(19) United States
(12) Patent Application Publication
(10) Pub. No.: US 2011/0096923 A1
(43) Pub. Date: Apr. 28, 2011

(54) Block cipher

(76) Inventor: Clemens Karl Berhard Röllgen, Munich (DE)

(21) Appl. No.: 12/925,347

(22) Filed: Oct. 21, 2010

(30) Foreign Application Priority Data
Oct. 23, 2009 (DE) 10 2009 050 493.1

(51) Int. Cl. H04L 9/28

(52) U.S. Cl. 380/28

(57) ABSTRACT

The method provided is for the encryption of data block by block, but unlike conventional methods like DES or AES, with a variable and substantially greater block length. The enciphering operations depend not only on the key, but also on the length of the plaintext blocks. The method meets the Strict Avalanche Criterion much better than conventional ciphers and blocks do not need to be padded. The method that additionally partitions outsized blocks executes the following steps:

Derivation of the internal state of the method from the key, pseudorandom permutation of plaintext bits or groups of plaintext bits, partitioning of outsized plaintext data blocks, execution of at least three unbalanced Feistel network rounds with round functions having the ability to output results with variable length and bit-by-bit exclusive-or combination with output of round functions within the Feistel rounds.

### CROSS-REFERENCE TO RELATED APPLICATIONS

European Patent #: EP 1 069 508 B 1, Cryptographic Method Modifiable During Run Time. Roellgen, Bernd. Apr. 7, 2000.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable

### INCORPORATION-BY REFERENCE OF MATERIAL SUBMITTED ON A COMPACT DISC

Not Applicable.

### BACKGROUND OF THE INVENTION

The invention relates to a symmetric method to encrypt data block by block, but unlike conventional methods like DES or AES with a variable and much greater block length. Symmetric encryption methods are systems for which the sender of a message, as well as the receiver, both use the same key. The key must be agreed upon prior to sending the message, e.g. through a key exchange using the Diffie-Hellman- or RSA algorithm.

Among the classic symmetric encryption methods is the Caesar Cipher, DES (Data Encryption Standard), AES (Advanced Encryption Standard), but also the One-Time-Pad, which is so far the only encryption method with theoretically proven security. A large number of modern encryption algorithms that are considered to be secure, are based on the substitution-permutation-network that has been developed by Horst Feistel at IBM in the 1970' and that is known as Feistel Cipher. Luby and Rackoff were able in 1988 to provide a mathematical proof for the security of a Feistel network with three rounds and with nonlinear round functions.

For the classic Feistel cipher are plaintext blocks divided in two sub-blocks with identical size. The size of the plaintext blocks can in principle be chosen freely. Quite common are 64 and 128 bit. Blocks of at least this size prevent classic codebook attacks effectively. Each block is divided into two halves of equal size (L₀ and R₀) and the content is encrypted in n rounds with different keys, that are all derived from a single key. In the end are the two resulting halves concatenated. The following round formula is applied in round i of n rounds in total:

Lᵢ=Rᵢ₋₁;

Rᵢ=L_{i-⊕ƒ(}R_{ᵢ₋₁}_{,K}_{ᵢ}₎;

ƒ is the so-called round function and Kᵢ the respective round key. The ciphertext is the union of the ordered bit groups Lₙ·Rₙ after n rounds.

Decryption is carried out by applying the round functions in reverse order. The round functions themselves do not need to be invertible.

So-called “unbalanced Feistel networks” are as well known. In this case are the two halves L and R not equal in length or a block is divided for the round functions into more than two parts. The security proof by Luby and Rackoff was especially provided for balanced Feistel networks. If the left string Lᵢ₋₁ is for example very long while the right string Rᵢ₋₁ comprises only a few m Bit, will the round function ƒ(Rᵢ₋₁, Kᵢ) almost entirely depend on the round key Kᵢ and, due to its length, only little by the right string Rᵢ₋₁. Attack security of an unbalanced Feistel network is yielded from the general proof by Luby and Rackoff. The attack security is directly proportional with the factor 2^{m}. m is the length of the shorter group of ordered bits of the two ordered groups of bits L and R in bit. Unbalanced Feistel networks are consequently only rarely used because the attack security is, according to the general proof by Luby and Rackoff, only optimal for balanced Feistel networks.

One of the decisive advantages of Feistel ciphers is the property that all data bits within a ciphertext block depend on all data bits in the plaintext block. Horst Feistel gave distinction for this feature by the term “completeness”. Today is this desirable feature of an encryption algorithm, that a little change in the plaintext and not only the key leads to a drastic change in the ciphertext, more generally known as “strict avalanche criterium (SAC)”. The SAC is satisfied if half of the bits in the ciphertext change their state if the state of only one bit of the plaintext changes. Encryption algorithms with a short block length exhibit by nature the disadvantage that only a few ciphertext bits can change their state. The reason is solely their limited block length. Ciphertext blocks of a block cipher that is operated in CBC mode depend only on previously encrypted plaintext blocks, but not in turn from plaintext blocks that are yet to be encrypted. When Cipher Block Chaining (CBC) is used, each plaintext block is exclusive-or combined with the previous ciphertext block. The high quality of a block cipher with comparably big blocks with respect to the SAC cannot be obtained with a block cipher that features smaller blocks and that is used in CBC mode or in any other mode of operation. For synchronous stream ciphers there exists no dependence on groups of plaintext bits at all due to the construction of the cipher per se.

The average block length of the plaintexts that are transmitted or stored worldwide allows for using comparably huge block lengths for block ciphers. The maximum packet size for a transmission protocol (MTU) in the network layer (layer 3) of the OSI model, that can be sent to the data link layer (layer 2) without fragmentation, is 1500 byte for Ethernet, 1492 bytes for PPPoE and even 9000 byte for Gigabit Ethernet. MTU stands for “Maximum Transmission Unit”. Instead of encrypting 8 byte blocks block by block, as this is the case for DES, or 16 byte blocks, if AES, Twofish, IDEA, RC6, Magenta or Serpent is employed, nothing can be said against e.g. encrypting 256 bytes or 1024 bytes at once. By doing this, the Strict Avalanche Criterion (SAC) can thus be met by far better. There is although an inherent disadvantage in doing this. As a fixed block size is used, more data than there are plaintext bytes must be transmitted. If a plaintext frame e.g. ends at byte # 513 and a block cipher with 512 byte block length is used, then the last plaintext block must be padded with 510 bytes. This leads to the transmission in excess of 510 bytes. Blocks with variable length or the short block lengths that are common today produce relief. A totally variable length of the plaintext data stream and unchanged length of the resulting ciphertext has so far only been realized with stream ciphers like ARCFOUR. Such methods are in use today in WLAN routers in order to encrypt Ethernet data packets. Block encryption algorithms with configurable block length, which results in a variable block length with very limited variability, are known. The widespread algorithms, such as AES, DES, Twofish, IDEA, RC6, Magenta and Serpent although feature strictly fixed block lengths, but can in part be operate with a variable key length.

The configurable block ciphers that are known can only be configured to block lengths of a power of 2 like 64, 128, 256, 512 or 1024 bit. The greater the block length, the more problematic becomes the logical necessity to pad blocks that are not completely filled with user data. Dummy data is thus appended to the plaintext and excessive data traffic results. Padding of plaintext can also lead to significantly longer ciphertext files than the corresponding plaintext files.

Attacks against a block cipher can naturally only be exercised on the known features of the method. The fixed block length, as it is common for the majority of known methods, helps for statistical analysis over the entire keyspace. Also is a configurable block length of a block cipher not an insurmountable obstacle for successful cryptanalysis. Analysis complexity does not inevitably increase with the number of block lengths if decisive features of the analyzed algorithm remain constant.

All known block encryption algorithms exhibit the disadvantage that block lengths are much shorter than the average plaintext length and that the block length is fixed or at best configurable. This makes attacks against implementations of known methods possible. Constant start sequences (headers) in TCP- and UDP data packets can potentially reveal the use of a constant key as well as repeatedly occurring plaintext. Average plaintexts are e.g. UDP- or TCP data packets that are e.g. encrypted by WLAN routers using a symmetric cipher prior to their transmission. In many cases are such packets longer than 4000 bit (500 byte). Image files, music files, but also text documents are rarely shorter than 80000 bit (10000 byte). The by far most popular block encryption methods although encrypt at best only 128 bit at a time. The significant discrepancy between block lengths of popular block ciphers and the average packet size that has increased over the past decades makes clear that the Strict Avalanche Criterion (SAC) is today increasingly insufficiently satisfied over the entire length of typical data packets. The following example of a constant header in data packets points up that the SAC is clearly met much better by increasing the block length. If a TCP data packet is sent without partitioning, but encrypted with a Feistel Cipher in one piece, together with a constant header, block counter and all user data, the probability for the occurrence of repeated ciphertexts decreases decisively. Block counters are an integral part of most Internet protocols.

### BRIEF SUMMARY OF THE INVENTION

The method provided is for the encryption of data with a block cipher with the following features and steps:
The sizes of plaintext blocks can vary in a wide range,
Ciphertext blocks are neither smaller nor greater in size than the corresponding plaintext blocks,
The internal state of the method is derived from the key,
Pseudorandom permutations of plaintext bits or of groups of single plaintext bits are executed depending on the original size of the plaintext block as well as the key,
Big plaintext blocks are partitioned into blocks of different sizes whereat the block sizes are computed in a pseudorandom way depending on the original size of the plaintext block as well as the key,
Each partitioned block of data is encrypted by executing the following steps:
   Execution of a first Luby-Rackoff round with a preferably long left binary string and a short right binary string,
   Execution of a second Luby-Rackoff round with a preferably short left binary string and a long right binary string,
   Execution of a third Luby-Rackoff round with a preferably long left binary string and a short right binary string.

### DETAILED DESCRIPTION OF THE INVENTION

The invention underlies the problem of a method for the encryption of data block by block with a variable and much greater block length than the typical block lengths of conventional ciphers like AES and DES.

A block cipher with variable block length that is according to the invention first derives from the key the following resources: all round keys, initialization of all variables that are needed to operate pseudorandom number generators, computation of permutation tables. The entire internal state of the method is solely determined by the key. In order to derive the internal state from the key it is possible to use compression functions like MD5, SHA-1 or Whirlpool, but also pseudorandom number generators or any other combination of nonlinear and non-invertible functions that are suitable for this purpose. For many applications (of a cipher) it is not at all a downside if the execution of this procedural step comprises of a substantial amount of computations. As an example will the participants of an encrypted telephone call not even notice if this first procedural step takes 0.1 or 0.3 seconds to execute several million machine instructions. The 10.000 . . . 100.000 fold expenditure of time in comparison with conventional block ciphers is although a noticeable obstacle for an attacker. The testing of a multitude of possible key combinations (Brute Force Attack) consumes a number of computation operations that is lower by several orders of magnitude for trying to break a conventional block cipher with the Brute Force Attack. The same is true for material usage and energy consumption that is needed to apply this attack.

In a second procedural step are bytes, words, double words or ordered groups of plaintext bits of a size that results in minimal of computational expense on a commercial microprocessor permuted. According to the current state of technology this is currently 32 or 64 bits. The permutation can be executed by exchanging ordered groups of bits, by using a table or by some other data structure that is suitable for this purpose, or by some other algorithm like the “Fisher-Yates Shuffle”. This procedural step provides the formation of new groups of plaintext bits in an unpredictable way. Moreover it prevents effectively that the subsequently applied unbalanced Feistel networks present a noticeable contact surface. This procedural step can alternatively be executed as final procedural step. It then ceases to be effective to conceal the asymmetry the unbalanced Feistel network. The operation depends from the key as well as from the respective block length of the plaintext. This causes the additional hardening of the method against attacks.

In a third procedural step are big plaintext blocks truncated into smaller blocks. These smaller blocks are small enough so that they can be processed in the subsequently executed process steps with the available resources. The resulting block sizes vary in a wide range. The block sizes are computed from the key as well as from the length of the original plaintext in a pseudorandom way. Plaintext blocks up to a certain threshold, that ideally can be configured, shall although not be partitioned. If e.g. most plaintext blocks of an internet telephony session are no longer than the MTU size of approximately 1 kilobyte and if a block cipher that is according to the invention can process blocks of that size with the available resources on all target systems without partitioning, the SAC is by far better satisfied than it could otherwise be satisfied with partitioning. Data packets carrying speech data of an internet telephony session naturally vary noticeably in their lengths and they contain a block counter, so that attackers do neither receive data packets with always identical size nor known plaintext or ciphertext.

If it is although necessary to encrypt a very big file on a PC or some other universal computer, there are basically sufficient resources available today for a block cipher that is according to the invention to encrypt 10 kilobyte of 100 kilobyte at once. Due to the characteristic of a block cipher that is according to the invention to derive the length of partitioned plaintext chunks and the (worker) key from a nonlinear and non-invertible function, an attacker is not even able to guess the actual sizes of the ciphertext blocks. It is possible to determine the partitioning sizes in advance by using a table or to compute the size of the respective next ciphertext block in a loop. The remaining length of plaintext bytes is yielded by subtracting the length of the next ciphertext block from the remaining number of bytes. The result is buffered subsequently for the next cycle. An advantageous embodiment of a block cipher that is according to the invention is designed so that small block lengths for the final blocks cannot occur. The successive transformation of the partitioned plaintext blocks into ciphertext blocks is performed by the following procedural steps in at least three procedural steps. The unbalanced Feistel network is preferably realized by a first Luby-Rackoff round with a long left binary string and a short right binary string, followed by a second Luby-Rackoff round with a short left binary string and a long right binary string, which is finally completed by a third Luby-Rackoff round with a long left binary string and a short right binary string. The operation can be described mathematically as follows:

ψ(ƒ₁, ƒ₂,ƒ₃,)(L·R)=[R⊕ƒ₂(L⊕ƒ₁(R))]·[L⊕ƒ₁(R)⊕ƒ₃(R⊕ƒ₂(L⊕ƒ₁(R)))]
with
L, R: left and right binary string (bit string).
⊕: bit by bit weise exclusive-or (XOR) function.
a·b: catenation of two ordered groups of bits (bit strings) a and b.
ƒ₁, ƒ₂, ƒ₃: nonlinear and non-invertible round functions. The key K determines the sequence of pseudorandom numbers of the round functions has been omitted from the formula for the sake of simplicity.
ψ(ƒ₁, ƒ₂, ƒ₃)(L·R): transformation of the catenation of the left and the right bit strings L and R.

The length of the left bit string L can be chosen with almost no constraint. In order to provide this capability, it is an absolute requirement that the round function ƒ₁ can generate bit strings of arbitrary length. ƒ₁ can e.g. be a hash function. In this case it is even possible for the right string R to be of arbitrary length. It is thus always possible to exclusive-or combine the left bit string L bit by bit with ƒ₁(R). In analogy to ƒ₁ can ƒ₂ and ƒ₃ as well be designed so that these functions can also compress bit strings of arbitrary length. A sequence of pseudo random numbers of arbitrary length can e.g. be yielded from cyclically feeding back the output bit string of the respective resulting hash to the input of the round function. Such an embodiment of a Luby-Rackoff construction can transform short, as well as long plaintext blocks into ciphertext blocks without yielding longer ciphertext blocks from the respective plaintext blocks. However it makes in turn no sense to encrypt blocks that are shorter than 64 bit. The danger that e.g. a codebook attack could be mounted successfully on the cipher would be too big.

Therefore a certain minimum length should be kept for the plaintext blocks. The upper limit for plaintext block size is although only limited by the size of the random access memory of the target system.

It makes sense to keep a fixed size for the right bit string R but in exchange to let the left bit string L be variable in a wide range. In this case can the round functions ƒ₁, as well as ƒ₃ be implemented as pseudorandom number generators, each using the right bit string R as parameter. If in addition to this the round function ƒ₂ is implemented as a hash function, processing speed of the method is maximized. The round functions ƒ₁ and ƒ₃ can be initialized especially fast as the number of parameters is small and they can generate long sequences of pseudorandom numbers that are logically combined with the respective left bit string L. The round function ƒ₂ can be implemented as classic hash function in an optimized way so that even large amounts of data can be compressed fast. Known hash functions as e.g. SHA-256 or Whirlpool can be used for the implementation of the round function ƒ₂.

Decryption is carried out by applying the round functions in reverse order. The permutation step is although executed as final step.

The partitioning of oversized plaintext blocks, as well as derivation of the internal state of the block cipher method from the key and additionally the need of all other procedural steps requires for efficiently generating pseudorandom numbers in dependence of the key. EP 1 069 508 B1 teaches how complex pseudorandom number generators can be compiled from passwords by stacking pseudorandom number generator primitives. In this connection a number of consecutively executed pseudorandom number generator primitives share and change the internal state during their execution. In lieu of the compilation process, an interpreter can alternatively call the pseudorandom number generator primitives one after the other. The sequence can e.g. be executed very efficiently by all universal microprocessors by calling function pointers that are stored in an array. Instead of the commonly fixed construction of conventional ciphers does the polymorphic construction of pseudorandom number generators offer the possibility to frame frequently used function blocks of a cipher within an essentially fixed structure in dependence of the respective key completely variable. Attackers hence find a design that they are in principle familiar with, but are confronted with a large number of key-dependent and possible different shapes of sub-functions that are all in equal measure probable to occur. In contrast to the popular fixed algorithms with a rigid construction like AES or DES, it is unlikely that intensive cryptanalysis reveals constant, key-independent weaknesses. A method that is according to the invention can be realized especially beneficial by using the pseudorandom number generators as described in EP 1 069 508 B1. Not only is the (partition) block length, but also the block cipher itself dependent on the key. A minimum of predictable characteristics is yielded for such an especially advantageously realized method that is according to the invention. In contrast to this are block sizes as well as the entire method of widely used block ciphers as AES completely fixed.

### BRIEF DESCRIPTION OF DRAWINGS

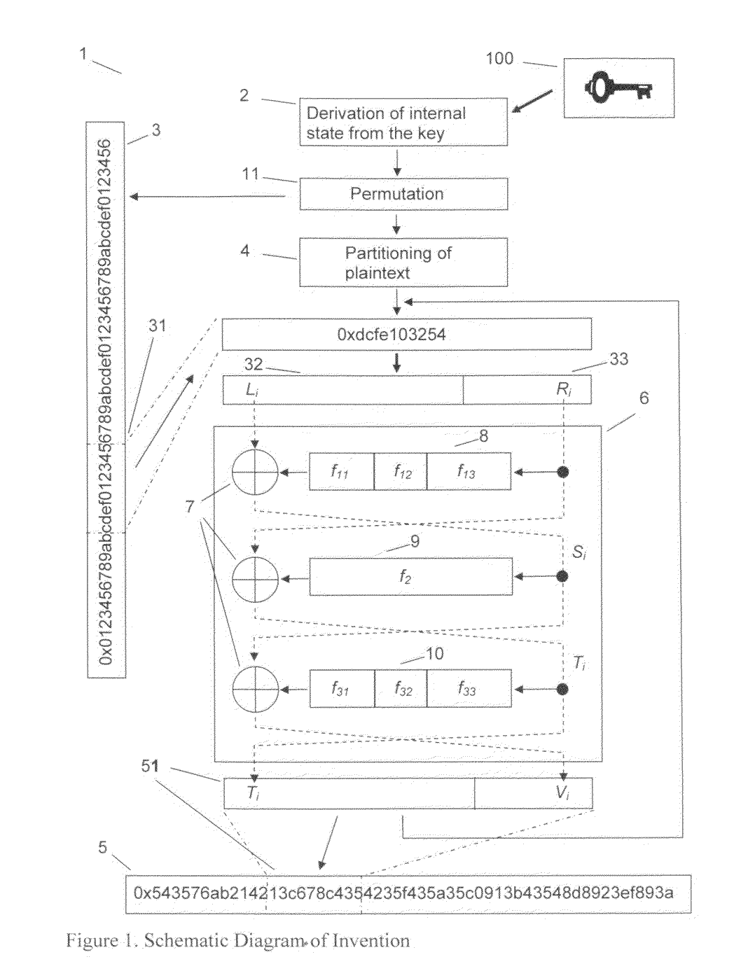

The schematic diagram (FIG. 1) represents a method to encrypt data block by block labeled with the reference sign (1) so that the length of the ciphertext equals the length of the plaintext, a block can be longer than 10000 bytes, each bit in a block depends on each other bit and that blocks that are too big for the target machine get partitioned into blocks of different sizes so that the deficiencies of known block ciphers do not occur.

The block cipher (1) possesses a first procedural step (2) that initializes the method (1) with the key (100). Thereby are all variables of the method (1) derived from the key (100). In the next procedural step (11) the plaintext block (3) is permuted in order to increase the immunity to linear cryptanalysis. This is e.g. performed by exchanging groups of bits pseudorandomly in this procedural step (11). If the permuted plaintext block (3) is bigger than the maximum block length that the method (1) can handle, the method (1) partitions the permuted plaintext block (3) to partial blocks. One of the partial blocks is labeled with the reference sign (31) substitutional for all other partial blocks. A permuted plaintext block (3) can be partitioned by the partitioning step (4) in a pseudorandom way into different numbers of partial blocks (31) of different sizes dependent on the key (100) as well as on the length of the permuted plaintext block (3).

Each of the partial blocks (31) is encrypted in the remaining procedural steps. The left part with variable length (32) of the partial block (31) and right part with fixed length (33) of the partial block (31) are transformed with mutual dependence by the Luby-Rackoff construction (6) into the ciphertext block (51). In each of the three rounds of the Luby-Rackoff construction (6) are the pseudorandom numbers generated by the round functions (8), (9) and (10) exclusive-or combined (7) with the data stream. Alternatively to bit by bit exclusive-or operations (7) it is possible to use addition or subtraction operations. Besides can combinations of bit rotation operations with addition-, subtraction- or exclusive-or operations be applied. During decryption of data it is although necessary to execute the respective complementary operation. In an advantageous embodiment is the respective operation (7) selected in a pseudorandom way.

The round functions with a short right bit string Rᵢ, Tᵢ (8), (10) preferably consist of several different nonlinear functions ƒ₁₁, ƒ₁₂, ƒ₁₃ for the first round function (8), as well as ƒ₃₁, ƒ₃₂, ƒ₃₃ for the third round function (10). Due to the characteristic of ƒ₁₁, ƒ₁₂, ƒ₁₃, as well as ƒ₃₁, ƒ₃₂, ƒ₃₃, if realized as pseudorandom number generators, to allow for initialization with only a few data bits, but at the same time to have to compute large amounts of data, more than one thread can e.g. execute the functions ƒ₁₁, ƒ₁₂, ƒ₁₃ and ƒ₃₁, ƒ₃₂, ƒ₃₃ for the first and the last round function (8) and (10) in parallel. This saves CPU time if big permuted plaintext blocks (3) need to be encrypted. It is as well possible to portion the logical combination steps (7) out to several threads. Parallelization of procedural steps allows for using a number of processor cores at once. Modern microprocessors for the use in universal computers like PCs and servers today commonly feature at least two processor cores, which in turn commonly possess dedicated cache memory for instructions and data and thus largely operate without the need to access the shared data- and address bus. None of the procedural steps (2), (4), (11), (7), (8), (9) and (10) although require execution of the method (1) on microprocessors with more than one core. The procedural step for the initialization (2) of the method (1) with the key (100) is besides especially advantageously implemented if all operations require to be executed sequentially and if consequently no parallelization is possible. In this case an attacker cannot save time and execute operations in parallel.

The generation of pseudorandom numbers for the second Luby-Rackoff round (9) can was well be parallelized. The round function ƒ₂ (9) can, according to the illustration, be realized as a single hash function or alternatively by several hash functions that are executed in parallel to save CPU time. The hash functions executed in parallel compress different chunks of the right bit string Sᵢ. After one-time execution, or when indicated, repeated execution of the Luby-Rackoff construction (6) are the computed ciphertext blocks (51) saved. As soon as the entire plaintext block (3) has been transformed into the ciphertext block (5), the method (1) ends.

1. A block encryption method, the method comprising the steps of:
Derivation of the internal state of the method from the key;
Plaintext blocks having a variable length;
Pseudorandom permutation of plaintext bits or groups of plaintext bits subsequent to derivation of the internal state from the key with dependence on the key, as well as the size of the respective plaintext data block;
Partitioning of permuted plaintext data blocks, that exceed the resources available to the method or a predefined threshold, subsequent to the permutation step with dependence on the key, as well as the size of the respective plaintext data block;
Encryption of permuted and partitioned plaintext data blocks by executing a Luby-Rackoff construction, which consists of at least three unbalanced Feistel network rounds, in a loop;
The bit-by-bit exclusive-or combination operations that are part of the Luby-Rackoff rounds featuring variable word length;
The round functions being part of the Luby-Rackoff rounds having the ability to output results with variable length.

2. The block encryption method as recited in claim 1, wherein the pseudorandom permutation of plaintext bits or groups of plaintext bits is omitted or, instead of being executed after derivation of the internal state from the key, the step is executed as final step of the method in order to permute the ciphertext.

3. The block encryption method as recited in claim 1, wherein the pseudorandom permutation of plaintext bits or groups of plaintext bits is extended or replaced by at minimum one additional and invertible operation, which includes bit-by-bit exclusive or-, addition- and subtraction operations of a pseudorandom number sequence or the encryption with a block- or stream cipher.

4. The block encryption method as recited in claim 1, wherein the bit-by-bit exclusive-or combination operations that are part of the Luby-Rackoff rounds featuring variable length can be replaced by invertible and pseudorandomly selected addition-, subtraction-, and bit rotation operations or by combinations with these operations.

5. The block encryption method as recited in claim 1, wherein the round functions and the bit-by-bit exclusive-or combinations operations both being part of the Luby-Rackoff rounds can be executed not only on one processor core but on several processor cores in parallel.

6. The block encryption method as recited in claim 1, wherein the mode of operation of the round functions, the partitioning step, the pseudorandom permutation step, the exclusive-or combination operations and/or the derivation of the internal state of the method from the key is determined by at least one polymorphic pseudorandom number generator.

7. The block encryption method as recited in claim 1, wherein the derivation of the internal state of the method from the key comprises at least ten million machine instructions.
